(19) United States
(12) Patent Application Publication
(10) Pub. No.: US 2026/0145653 A1
(43) Pub. Date: May 28, 2026

(54) ACTUATOR DEVICE FOR A BRAKE-BY-WIRE BRAKING SYSTEM AND BRAKING SYSTEM

(71) Applicant: HELLA GMBH & CO. KGAA, Lippstadt (DE)

(72) Inventor: Christian Iseke, Paderborn (DE)

(21) Appl. No.: 19/392,553

(22) Filed: Nov. 18, 2025

(30) Foreign Application Priority Data
Nov. 22, 2024 (DE) 102024134505.5

(51) Int. Cl. B60T 8/171; B60T 8/172; B60T 13/74; B60T 17/22; F16D 55/226; F16D 65/18; F16D 66/00; F16D 66/02; F16D 121/24; F16D 125/40; F16D 125/48

(52) U.S. Cl. CPC B60T 8/171; B60T 8/172; B60T 13/746; B60T 17/22; F16D 55/226; F16D 65/18; F16D 66/026; B60T 2270/82; F16D 2066/003; F16D 2066/005; F16D 2066/006; F16D 2121/24; F16D 2125/40; F16D 2125/48

(57) ABSTRACT

An actuator device for a brake-by-wire braking system is provided. The device includes an electric motor, a gearing system interposed between an actuator output shaft and the electric motor, and a sensor device including a motor rotation angle sensor for detecting the rotation angle position of the rotor of the electric motor and an actuator output rotation angle sensor for detecting a rotation angle of an actuator output shaft. The actuator device also includes a control unit designed to control the electric motor and provide a drive torque to the actuator output shaft. The control unit has a torque determination module designed to determine the drive torque at the actuator output shaft based on the motor parameters of the electric motor and on the sensor signals of the motor rotation angle sensor and the actuator output rotation angle sensor.

### CROSS-REFERENCE TO RELATED APPLICATIONS

The present application claims the benefit of German Patent Application 10-2024-134-505.5, filed Nov. 22, 2024, the disclosures of which is incorporated by reference.

### FIELD OF THE INVENTION

The invention relates to an actuator device for a brake-by-wire braking system, including an electric motor which has a rotor and a stator, a gearing system which is interposed between an actuator output shaft and the electric motor, a sensor device which comprises a motor rotation angle sensor for detecting the rotation angle position of the rotor of the electric motor and a control unit which is designed to drive the electric motor to provide a drive torque to the actuator output shaft, and wherein the control unit has a torque determination module which is designed to determine the drive torque at the actuator output shaft caused by the electric motor from the motor parameters of the electric motor.

### BACKGROUND OF THE INVENTION

The so-called brake-by-wire braking systems essentially differ from conventional braking systems in that there is no mechanical coupling between a brake pedal and a braking device. In brake-by-wire braking systems, the actuation or displacement of the brake pedal is detected by a sensor and, based on this, an actuator device is controlled by a control unit, wherein the actuator device acts on the braking device in such a way that a situation-specific braking process is caused.

The actuator devices required to actuate the braking device are generally known from the state of the art and are usually of electromechanical design. The actuator devices have at least one electric motor, which is activated as required by a control unit in such a way that an actuator output shaft is loaded with a specific drive torque by the electric motor. A gearing system is usually interposed between the electric motor and the actuator output shaft. The actuator output shaft is operatively connected to the braking device via a transmission device that converts a rotational movement of the actuator output shaft into a translational movement, so that, by the activation of the electric motor and the resulting rotation of the actuator output shaft, the braking device is actuated, and a braking process is initiated. The clamping force acting on the braking device depends, in particular, on the drive torque provided by the electric motor and present at the actuator output shaft, in such a manner that the change in the drive torque also changes the clamping force between the brake body which is connected to a vehicle wheel in a torque-transmitting manner, and the displaceably mounted brake pads which are in contact with the brake body in the braking condition. By changing the clamping force, the braking effect of the vehicle can be adjusted.

The activation of the electric motor is dependent on the request of the driver, i.e. the brake pedal actuation by the driver, as well as other influencing factors, such as, for example, the wear condition of the brake, the wear condition of the tires, the condition of the road surface and the current driving situation. To take into account the majority of influencing factors when activating the electric motor, a characteristic map is usually stored in the control unit, which serves to ensure that a drive torque that takes into account the predefined influencing factors to be considered is provided by the activation of the electric motor, whereby a clamping force required for the situation can be provided between the brake body and the brake pads, and thus a braking effect required for the situation can be provided. The clamping force caused by the activation of the electric motor is usually determined additionally, and the activation of the electric motor is adjusted based on this if necessary.

Such an actuator device is known, for example, from DE 10-2012-206-223 A1. To determine the currently acting clamping force caused by the electric motor and thus the drive torque generated by the actuator device, the electrical parameters of the electric motor, i.e. the current and the electrical voltage, are used, wherein the drive torque is determined from the electrical parameters, taking into account the gear ratio of the gearing system, and the clamping force is inferred based on this.

When the electric motor is activated and, thus, when the drive torque is provided at the actuator output shaft and the clamping force between a brake body, which is non-rotatably connected to the vehicle wheel, and the brake pads, deformations of the actuator device occur, among other things, which lead to incorrect results when determining the drive torque and thus the clamping force.

### SUMMARY OF THE INVENTION

The task of the invention is to provide an actuator device for a brake-by-wire braking system, by means of which the drive torque caused by the actuator device and thus the clamping force acting on a braking device, which is dependent on the drive torque, can be determined in a simple, reliable and cost-effective manner.

According to the invention, the sensor device has an actuator output rotation angle sensor, which is preferably designed as an inductive rotation angle sensor, for detecting a rotation angle of the actuator output shaft, wherein the drive torque determination module is designed to detect the rotation angle of the actuator output shaft, comparing a rotation angle at the actuator output shaft determined from the sensor signals of the motor rotation angle sensor and a rotation angle determined from the sensor signals of the actuator output rotation angle sensor, determining a rotation angle difference value based thereon and determining the drive torque at the output shaft based on the motor parameters and the rotation angle difference value. Furthermore, the actuator device can comprise current sensors for detecting the motor current, sensors for detecting the motor phase voltages and sensors for detecting the temperature on the electric motor and/or on a circuit board.

When a clamping force is built up between the brake body and the brake pads of a braking device by activating the electric motor, all components of the actuator device that participate in the power transmission, in particular the gearing system, are mechanically loaded. In principle, the motor torque and thus the drive torque would increase when the brake pads are applied to the brake body and the electric motor is activated, wherein the actuator output shaft would come to a standstill. Due to the fact that the components of the actuator device are not optimally rigid, a mechanical load on the components of the actuator device inevitably leads to a deformation, i.e. an elastic deformation, of the components. In other words, the components yield under load and return to their original state when the load is released.

When determining the drive torque on the actuator output shaft and, thus, when determining the clamping force, it is crucial that the drive torque determined solely on the basis of the electrical parameters of the electric motor is distorted by the deformation of the components due to the existing load, which means that the resulting clamping force is likewise distorted due to the deformation.

By additionally comparing the rotation angle at the actuator output shaft determined from the sensor signals of the motor rotation angle sensor and the rotation angle determined from the sensor signals of the actuator output rotation angle sensor, the deformation of the components of the actuator device and the torque portion which is not present in the clamping force due to the deformation of the components can be determined or estimated, and this can be taken into account when determining the drive torque and thus when determining the clamping force. In other words, by comparing the rotation angle at the actuator output shaft determined based on the sensor signals of different rotation angle sensors, it is possible to determine how the actuator device yields under the present load and to draw conclusions about the torque loss for the clamping force based on this.

This makes it possible to increase the accuracy and reliability in determining the drive torque and thus in determining the clamping force in a simple and cost-effective way. In addition, the actuator device contains all the components required to activate or regulate the electric motor, whereby only a mechanical interface between the actuator device and the braking device or a transmission device needs to be provided.

Preferably, an actuator housing is provided which defines a housing interior, with the electric motor, the gearing system and the sensor device being arranged in the housing interior. The actuator output shaft either protrudes from the actuator housing, or a component of the transmission device protrudes into the interior of the housing. The actuator output shaft is preferably non-rotatably connected to an input element of a transmission device via a plug-in connection. In particular, the actuator output shaft and the input element are positively connected in the circumferential direction or in the direction of rotation, for example via a toothed or polygonal connection. Since all force-carrying and current-conducting components of the actuator device, in particular the sensors of the sensor device, are arranged in the actuator housing, only a mechanical coupling and no electrical coupling to the braking device or to the transmission device is required. In addition, no complex protection of individual components against the external environment is required, as all components are arranged in a common actuator housing and are separated from the external environment by the actuator housing.

In a preferred embodiment, the gearing system is a gearwheel mechanism. The gearing system preferably comprises several gear stages and is used to adapt the motor drive torque to a required torque range on the actuator output shaft.

Preferably, the control unit has a defect detection module which is designed to detect a defect in the actuator device by comparing the rotation angle at the actuator output shaft determined from the sensor signals of the motor rotation angle sensor and the rotation angle determined from the sensor signals of the actuator output rotation angle sensor. In particular, the rotation angles at the actuator output shaft determined from the sensor signals of the motor rotation angle sensor and the rotation angles determined from the sensor signals of the actuator output rotation angle sensor are compared with each other in a freewheel period, i.e. in a time interval in which the brake pads are moved in the direction of the brake body but are not in contact with the brake body. If the two determined rotation angles deviate from each other beyond a predefined threshold value, a defect in the actuator device is indicated. A deviation in the determined rotation angle below the threshold value indicates play in the gearing system, which is pressed out when the electric motor is activated. This means that by comparing the rotation angle on the actuator output shaft determined from the sensor signals of the motor rotation angle sensor with the rotation angle determined from the sensor signals of the actuator output rotation angle sensor, a defect in the actuator device can likewise be detected in addition to the more reliable determination of the drive torque on the actuator output shaft.

The problem is also solved by a braking system with a braking device which has a brake body that can be connected to a vehicle wheel in a torque-transmitting manner and at least one displaceably mounted brake pad that interacts with the brake body in the braking condition, an actuator device, and a transmission device which is interposed between the actuator device and the brake pad and is designed to convert a rotational movement of the actuator output shaft into a translational movement for loading the brake pad.

When a driver operates the brake pedal, the displacement of the brake pedal is detected by a sensor. The displacement of the brake pedal thus determines the request of the driver to brake and the requested intensity of the braking effect. As an alternative to operating the brake pedal, there may be a braking request from a driver assistance system. The sensor which detects the displacement of the brake pedal is connected to the control unit via a signal. Based on the sensor signal of the sensor detecting the displacement of the brake pedal and based on further input variables, such as, for example, the wear condition of the brake, the wear condition of the tires, the condition of the road surface and the current driving situation, the resulting clamping force is determined, and the input variables for controlling the electric motor are determined, the drive torque at the actuator output shaft caused by the electric motor is continuously determined from the motor parameters, and the sensor signals of the rotation angle sensors and the activation of the electric motor is adapted based on this.

The transmission device is preferably a screw drive, whereby a threaded spindle is non-rotatably connected to the actuator output shaft and a spindle nut is operatively connected to the brake pad, or the spindle nut is non-rotatably connected to the actuator output shaft and the threaded spindle is operatively connected to the brake pad. The actuator output shaft is preferably non-rotatably connected to an input element of a transmission device via a plug-in connection. In particular, the actuator output shaft and the input element are positively connected in the circumferential direction or in the direction of rotation, for example via a toothed or polygonal connection.

The braking device is preferably a disk braking device, wherein the brake body is a brake disk and the brake pads are mounted on a brake caliper in a translationally displaceable manner. Alternatively, the braking device can be a drum braking device.

The actuator device is preferably attached to the brake caliper. The actuator device is attached in particular by screwing the actuator housing to the brake caliper.

In a preferred embodiment, the control unit has a wear detection module which is designed in such a way that, based on the sensor signals from the actuator output rotation angle sensor, the amount of wear on the brake pads and/or the brake body is estimated. Here, two rotation angles, at which the brake pad is in contact with the brake body and which are determined at different times, are compared. In particular, a rotation angle is determined when the braking device is new and stored in the wear detection module. During subsequent use of the vehicle, i.e. at a later point in time, the rotation angle is determined again. If the rotation angle determined at a later point in time deviates from the stored rotation angle of the new condition, there is wear, particularly of the brake pads, whereby the amount of wear can be estimated via the amount of deviation between the rotation angles.

### BRIEF DESCRIPTION OF THE DRAWING

The invention is explained in more detail below with reference to the attached drawing. In the drawing:

FIG. 1 shows a cross-section through a braking system for a vehicle.

### DETAILED DESCRIPTION OF THE CURRENT EMBODIMENT

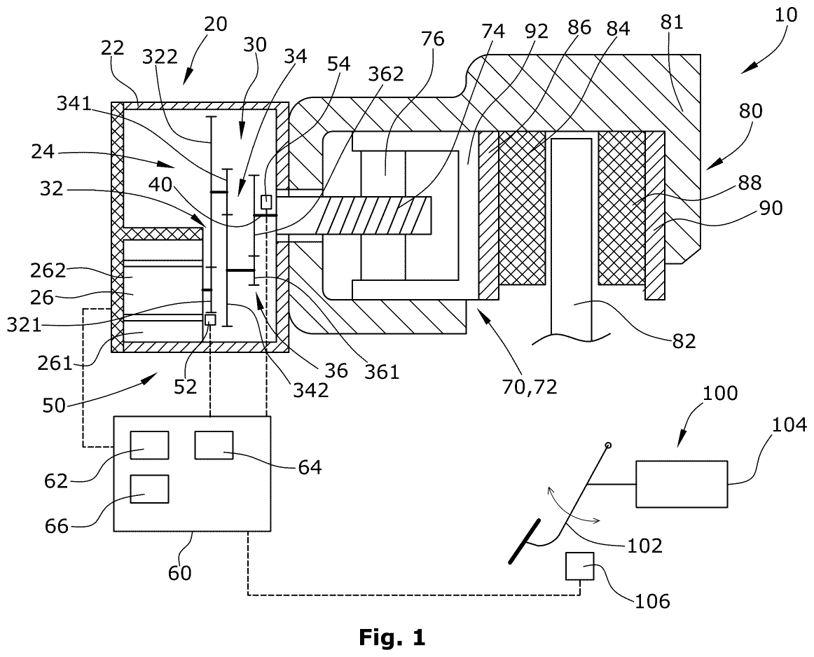

FIG. 1 shows an electromechanical braking system 10 for a vehicle, which is designed as a brake-by-wire braking system. The electromechanical braking system 10 comprises an actuator device 20, a transmission device 70, a braking device 80 and a pedal device 100.

The actuator device 20 has an actuator housing 22, an electric motor 26, a gearing system 30, a sensor device 50 and a control unit 60.

The actuator housing 22 delimits a housing interior 24, in which the electric motor 26, the gearing system 30 and the sensor device 50 are arranged. The actuator housing 22 is made of plastic.

The electric motor 26 comprises a stator 261 and a rotor 262, wherein the stator 261 is fixed to the actuator housing 22 and the rotor 262 is rotatably mounted on the actuator housing 22. The stator 261 is electrically connected to the control unit 60 so that the electric motor 26 is activated by the control unit 60. The rotor 262 is connected to the gearing system 30.

The gearing system 30 is designed as a gearwheel mechanism and has, as an example, three gear stages 32, 34, 36. A first gear stage 32 has a first gearwheel 321 forming a drive pinion of the electric motor 26 and a second gearwheel 322 which meshes with the first gearwheel 321. A second gear stage 34 has a first gearwheel 341, which is non-rotatably connected to the second gearwheel 322 of the first gear stage 32, and a second gearwheel 342, which meshes with the first gearwheel 341. A third gear stage 36 has a first gearwheel 361, which is non-rotatably connected to the second gearwheel 342 of the second gear stage 34, and a second gearwheel 362, which meshes with the first gearwheel 361. The second gearwheel 362 of the third gear stage 36 is non-rotatably connected to an actuator output shaft 40. All gearwheels 321, 322, 341, 342, 361, 362 and the actuator output shaft 40 are rotatably mounted on the actuator housing 22 via bearing means that are not shown in the figure.

The sensor device 50 comprises a motor rotation angle sensor 52 and an output rotation angle sensor 54. The motor rotation angle sensor 52 detects the rotation of the rotor 261 and is basically required for determining the position for activating the electric motor 26. The output rotation angle sensor 54, which is designed as an inductive rotation angle sensor, for example, detects the rotation of the actuator output shaft 40.

The transmission device 70 is designed as a screw drive 72, in particular as a ball screw drive. The screw drive 72 has a threaded spindle 74 and a threaded nut 76. The threaded spindle 74 is non-rotatably connected to the actuator output shaft 40. The threaded nut 76 is operatively connected to the braking device 80.

The braking device 80 comprises a brake caliper 81, a brake body 82 designed as a brake disk non-rotatably connected to a vehicle wheel not shown, two brake pads 84, 88 each attached to a carrier 86, 90 and a brake piston 92. At least the brake pad 84 is mounted on the brake caliper 81 in a translationally displaceable manner via the carrier 86, wherein the brake piston 92 is in contact with a side of the carrier 86 that faces away from the brake body 82. The brake piston 92 is operatively connected to the spindle nut 76 of the screw drive 72. The brake caliper 81 also serves to accommodate the transmission device 70. The actuator device 20 is designed as a separate assembly and is bolted to the brake caliper 81 via the actuator housing 22.

The pedal device 100 has a pivotably mounted brake pedal 102, which is arranged in a vehicle interior and can be actuated by a person in such a way that the brake pedal 102 is displaced due to the load imposed by the person. The brake pedal 102 is connected to a restoring unit 104 and serves to provide a restoring force when the brake pedal 102 is actuated, such that the operating feeling for the person corresponds to a familiar operating feeling known from a conventional braking system. The pedal device 100 further comprises a sensor 106, which is connected to the control unit 60 of the actuator device 20 via a signal and detects the displacement of the brake pedal 102.

When the vehicle is being driven and the brake pedal 102 is actuated by a person or by the driver, the brake pedal 102 is displaced, wherein the displacement of the brake pedal 102 is detected by the sensor 106. The sensor signals from the sensor 106 are transmitted to the control unit 60. Based on the sensor signals from the sensor 106 and other input variables, such as the wear condition of the brake pads 84, 88, the wear condition of the tires, the condition of the road surface and the current driving situation, the resulting clamping force to be set between the brake pads 84, 88 and the brake body 82 is determined and the required input variables for controlling the electric motor 26 are determined, in particular using a characteristic map. The electric motor 26 is activated accordingly, wherein the drive torque at the actuator output shaft 40, which determines the clamping force generated by the electric motor 26, is determined by a drive torque determination module 62 of the control unit 60 and the activation of the electric motor 26 is adapted based on this.

The determination of the drive torque at the actuator output shaft 40 occurs based on the motor parameters of the electric motor 26, i.e. based on the current and the electrical voltage, and based on the sensor signals of the motor rotation angle sensor 52 and the output rotation angle sensor 54. Here, the drive torque at the actuator output shaft 40 is initially determined or calculated based on the motor parameters of the electric motor 26, which are already known due to the control of the electric motor 26, and taking into account the gear ratio of the gearing system 30.

When a clamping force is built up between the brake body 82 and the brake pads 84, 88, all components of the actuator device 20 that participate in the power transmission, in particular the components of the gearing system 30 and the housing 22, are mechanically loaded. The mechanical load inevitably causes deformation of the components of the actuator device 20, which distorts the determination of the drive torque at the actuator output shaft 40, which is determined solely on the basis of the motor parameters of the electric motor 26, and thus the determination of the clamping force.

In order to reduce or avoid distortion when determining the drive torque at the actuator output shaft 40, the deformation or yielding of the components of the actuator device 20 under the present load is estimated and taken into account when determining the drive torque at the output shaft 40. Here, the rotation angle at the actuator output shaft 40 determined from the sensor signals of the motor rotation angle sensor 52 and taking into account the gear ratio of the gearing system 30 is compared with the rotation angle of the actuator output shaft 40 determined from the sensor signals of the actuator output rotation angle sensor 54. The deformation of the components of the actuator device 20 or the yielding of the components of the actuator device 20 is estimated on the basis of a rotation angle difference value determined from this, and the torque portion not present in the clamping force due to the deformation of the components is determined or estimated. The non-present torque portion is taken into account when determining the drive torque, which means that the clamping force can be determined with a high degree of reliability and accuracy.

The control unit 60 also comprises a defect detection module 64 and a wear detection module 66.

The defect detection module 64 is designed, by comparing the rotation angle at the actuator output shaft 40 determined from the sensor signals of the motor rotation angle sensor 52 and the rotation angle determined from the sensor signals of the actuator output rotation angle sensor 54, to detect a defect in the actuator device 40, for example a breakage of the gearing system 30. In particular, the rotation angles at the actuator output shaft 40 determined from the sensor signals of the motor rotation angle sensor 52 and the rotation angles determined from the sensor signals of the actuator output rotation angle sensor 54 are compared with each other in a freewheel period, i.e. in a time interval in which the brake pads 84, 88 are not in contact with the brake body 82. If the compared rotation angles deviate from each other beyond a predefined defect threshold value, a defect in the actuator device 20 is detected and appropriate measures are initiated.

The wear detection module 66 is designed to estimate the amount of wear of the brake pads 84, 88 and/or the brake body 82 based on the sensor signals of the actuator output rotation angle sensor 54, wherein two rotation angles that are present when the brake pad is in contact with the brake body are compared with each other. Here, a rotation angle of the actuator output shaft that is present in new condition, determined from the sensor signals of the actuator output rotation angle sensor 54 and stored in the wear detection module 66, is compared with a rotation angle determined from the sensor signals of the actuator output rotation angle sensor 54 at a later point in time, i.e. after use of the motor vehicle and thus after a plurality of braking operations. If the rotation angle determined at a later point in time deviates from the rotation angle determined in the new state, it is concluded that the braking device 80 is worn, whereby the amount of wear can be estimated using the amount of deviation between the rotation angles.

### List of Reference Numerals

10 braking system
20 actuator device
22 actuator housing
24 housing interior
26 electric motor
261 stator
262 rotor
30 gearing system
32 first gear stage
321 first gear of the first gear stage
322 second gear of the first gear stage
34 second gear stage
341 first gear of the second gear stage
342 second gear of the second gear stage
36 third gear stage
361 first gear of the third gear stage
362 second gear of the third gear stage
40 actuator output shaft
50 sensor device
52 motor rotation angle sensor
54 actuator output rotation angle sensor
60 control unit
62 torque determination module
64 defect detection module
66 wear detection module
70 transmission device
72 screw drive
74 threaded spindle
76 threaded nut
80 braking device
82 brake body
84 brake pad
86 carrier
88 brake pad
90 carrier
92 brake piston
100 pedal device
102 brake pedal
104 restoring unit
106 sensor

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An actuator device for a brake-by-wire braking system, comprising
an electric motor which has a rotor and a stator,
a gearing system which is interposed between an actuator output shaft and the electric motor,
a sensor device which comprises a motor rotation angle sensor for detecting the rotation angle position of the rotor of the electric motor, and
a control unit which is designed to drive the electric motor to provide a drive torque at the actuator output shaft, and wherein the control unit has a torque determination module which is designed to determine the drive torque at the actuator output shaft caused by the electric motor from the motor parameters of the electric motor,
wherein the sensor device has an actuator output rotation angle sensor for detecting a rotation angle of the actuator output shaft,
wherein the torque determination module is designed to compare a rotation angle at the actuator output shaft determined from the sensor signals of the motor rotation angle sensor and a rotation angle determined from the sensor signals of the actuator output rotation angle sensor, to determine a rotation angle difference value based thereon and to determine the drive torque at the actuator output shaft based on the motor parameters of the electric motor and based on the rotation angle difference value.

2. The actuator device according to claim 1,
wherein an actuator housing delimiting a housing interior is provided, and
wherein the electric motor, the gearing system. and the sensor device are arranged in the housing interior.

3. The actuator device according to claim 1,
wherein the actuator output rotation angle sensor is an inductive rotation angle sensor.

4. The actuator device according to claim 1,
wherein the gearing system is a gearwheel mechanism.

5. The actuator device according to claim 1,
wherein the control unit has a defect detection module which is designed to indicate a defect in the actuator device by comparing the rotation angle at the actuator output shaft determined from the sensor signals of the motor rotation angle sensor and the rotation angle determined from the sensor signals of the actuator output rotation angle sensor.

6. A braking system comprising:
a braking device which has a brake body that can be connected to a vehicle wheel in a torque-transmitting manner and at least one displaceably mounted brake pad that interacts with the brake body in the braking condition,
an actuator device according to claim 1, and
a transmission device which is interposed between the actuator device and the brake pad and is designed to convert a rotational movement of the actuator output shaft into a translational movement for loading the brake pad.

7. The braking system according to claim 6,
wherein the transmission device is a screw drive,
wherein a threaded spindle is non-rotatably connected to the actuator output shaft and a spindle nut is functionally connected to the brake pad, or
the spindle nut is non-rotatably connected to the actuator output shaft and the threaded spindle is operatively connected to the brake pad.

8. The braking system according to claim 6,
wherein the braking device is a disk braking device,
wherein the brake body is a brake disk, and
wherein the at least one brake pad is mounted on a brake caliper in a translationally displaceable manner.

9. The braking system according to claim 8,
wherein the actuator device is attached to the brake caliper.

10. The braking system according to claim 6,
wherein the actuator output shaft and the transmission device are connected to one another in a non-rotatable manner via a plug-in connection.

11. The braking system according to claim 6,
wherein the control unit has a wear detection module which is designed such that the amount of wear of the brake pads or of the brake body is estimated based on the sensor signals of the actuator output rotation angle sensor.
